(19) United States
(12) Patent Application Publication
(10) Pub. No.: US 2018/0371305 A1
(43) Pub. Date: Dec. 27, 2018

(54) WATER-BASED ENGINE COOLANT FOR USE IN TROPICAL ENVIRONMENTS, METHOD FOR MAKING AND USING SAME

(71) Applicants: Devendra Deo Narain SINGH, Varanasi (IN); Marco NUNES, Tacarigua (TT)

(72) Inventors: Devendra Deo Narain SINGH, Varanasi (IN); Marco NUNES, Tacarigua (TT)

(21) Appl. No.: 16/063,399

(22) PCT Filed: Jan. 5, 2017
(86) PCT No.: PCT/IB17/00052

§ 371 Date: Jun. 18, 2018

Related U.S. Application Data
(60) Provisional application No. 62/275,496, filed on Jan. 6, 2016.

(51) Int. Cl. C09K 5/20; C09K 5/10; C23F 11/12; C23F 11/18

(52) U.S. Cl. CPC C09K 5/20; C23F 11/182; C23F 11/124; C09K 5/10

(57) ABSTRACT

A water-based coolant formulated to reduce water evaporation and metal corrosion is provided, the coolant having between about 25 and about 100 ml/L extract of a humectant containing quinone compounds dissolved in water; and between about 1 and about 10 g/L of at least one corrosion inhibitor dissolved along with the extract of Aloe Vera. Also provided is a method for minimizing metal corrosion, the method comprising contacting metal surfaces with a solution of Aloe Vera extract.

### PRIORITY

The present application claims the benefit of priority as the nationalization of international application PCT/IB2017/000052, filed on Jan. 5, 2017, currently pending, which in turn claimed priority benefit of U.S. Provisional Patent Application No. 62/275,496, filed on Jan. 6, 2016, presently expired, both of which are incorporated by reference in their entirety herein.

### BACKGROUND OF THE INVENTION

### 1. Field of the Invention

This invention relates to a water-based coolant for engines, and more specifically the invention relates to a glycol-free water-based engine coolant for use in tropical environments.

### 2. Background of the Invention

The internal combustion engine revolutionized industrial growth and led to a phenomenal improvement in the quality of human life. Engines are now used in diesel and petroleum varieties and are used in driving trucks, tractors, generators, railway cars and many other mobile and stationary applications.

In spite of considerable research to improve the efficiency of engines to utilize the maximum amount of heat generated by combustion of fuels, only one-third of heat energy is utilized to propel engines with the remaining two-third's wasted. Of this wasted heat, about half is passed as exhaust and the other half is dissipated through the body of the engines. If the engine body does not sufficiently dissipate heat to the environment, the engine components will overheat, reducing the overall efficiency and life of the engine.

Loss of heat efficiency is a big challenge for the automobile sector, and therefore, efficiency is a subject of very intense research and development efforts. Early combustion engines utilized fans for cooling. Later developments featured water circulating through heat exchangers to cool running engines. Use of unadulterated water as an engine coolant continued into the middle of the 20th century.

Use of water as a cooling medium is problematic, especially in very cold climates where temperatures drop below the freezing point of water. Freezing temperatures increase water's volume (about 10 percent) and damage radiators, pipes, and pistons and sometimes contaminate engine fuels.

Water as a cooling medium is also problematic under warm weather conditions such as during the summer months of non-tropical climates and all year in tropical environments. Under summer or tropical weather conditions, unadulterated water may boil off or evaporate from cooling systems. Thus, unadulterated water as an engine coolant is problematic under warm weather conditions.

Plain water as an engine coolant has an additional disadvantage in that neat water causes corrosion of engine components. Corrosion of engine components reduces the overall life of engines.

To overcome these problems, the addition of alcohols, especially methanol, to water was adopted. Methanol, due to formation of hydrogen bonds with molecules of water, increases the boiling point of water and decreases its freezing temperature, making a water-methanol combination a better coolant than neat water. However, methanol is toxic to humans and animals. Further, like plain water, methanol corrodes engine components. Therefore, a suitable substitute for methanol was required.

Glycerol was found to be a suitable additive for this application. Glycerol increases the boiling point and decreases the freezing point of water more effectively than methanol. Blending glycerol with water for use an engine coolant began shortly after glycerol's introduction to the market. Thus, coolants using glycerol were extremely expensive when first available.

In 1927, the use of water-based coolants utilizing polyethylene glycol became popular, owing to its lower cost and its significant effect on the freezing point of water and lowering of evaporation losses. Polyethylene glycol is a poly hydric alcohol featuring two hydroxyl groups.

Mixing polyethylene glycol with water slightly raises water's boiling point but considerably reduces water's freezing point under the same mechanism i.e. hydrogen bonding. For example, the 1:1 mixture of water and glycol freezes at a considerably lower temperature than neat water (about minus 37° C.). However, the boiling point of the same mixture is only slightly raised (105° C.). Further, glycols have no effect on boiling point of water until added to make up at least 30% of the coolant volume. Due to economic reasons, most of the coolants available in the market use only up to this concentration of glycols in their formulations. The foregoing observations have caused engine coolants to be rebadged as “antifreeze.”

There are many other glycols such as diethylene glycol, triethylene glycol, tetraethylene glycol, propylene glycol, dipropylene glycol and hexylene glycol which are effective in decreasing the freezing point and increasing the boiling point of water. However, polyethylene glycol is the most effective and also the most economical of these glycols. Most modern coolants use 30-100 percent ethylene glycol or propylene glycol with water. These mixtures cause corrosion of metals and therefore corrosion of engine components. Such corrosion is a significant disadvantage for such coolants. To remedy the corrosive properties of ethylene glycol and or propylene glycol water-based coolants, modern coolants include various types of corrosion inhibitors. Some companies market water-free coolants that are 100 percent glycol or glycol or a combination of other organic materials as cooling fluid.

In light of the foregoing, the use of glycol-based anti-freezes in tropical climates, where temperatures rarely go below 20° C., has significant disadvantages. Glycols reduce water's ability to dissipate heat. Thermal conductivity of glycols is about 50% lower than water. Glycols also promote scale formation on the surface of radiators and adversely affect the performance of engines. At high temperatures, glycols decompose to form organic acids which adversely affect metals resulting in leakages of radiators.

Aside from the above, glycols are poisonous. Ethylene glycols are sweet in odor and taste and attract animals and children. When metabolized, ethylene glycols transform into glycolic and oxalic acids which damage kidney function. Thousands of cases of accidental inhalation of coolants by children and concomitant fatal injuries occur each year. The evaporative loss of water from aqueous-based coolants is a primary cause of concern for internal combustion engines used in tropical climates. Most of the engine coolants commercially available incorporate glycols in their compositions to control evaporation losses. As stated above, the glycols are very toxic. For example, acute oral toxicity (LD50) for ethylene glycol is 4700 mg/kg in liquid phase and >200 mg/m³ over 4 hours in vapor phase, both measurements representing doses for rats.

As a further disadvantage, Ethylene glycol and other glycols are non-biodegradable. Entry of ethylene glycol and other glycols into the environment (i.e. rivers, lakes, streams, and seas) poisons fish and other aquatic life.

A need in the art exists for a more eco-friendly coolant to minimize the poisoning and polluting effects of coolants currently being used in internal combustion engines, especially in tropical environments.

### SUMMARY OF INVENTION

An object of the invention is to provide a water-based coolant that overcomes many of the disadvantages of the prior art.

Yet another object of the invention is to provide a water-based coolant for use in tropical environments and other high-temperature environments. A feature of the invention is incorporating a hygroscopic substance in the coolant mixture. An advantage of the invention is that the substance serves as a humectant and prevents evaporation of the water even when used in the high temperature environs of internal combustion engines. A further advantage of the invention is that the invented water-based coolant prevents is rust and prevents water evaporation for an extended period (e.g., at least 12 months).

Still another object of the invention is to provide a water-based engine coolant that prevents corrosion of metals that come into contact with the coolant. A feature of the invention is the combination of dissolved corrosion inhibitors and hygroscopic substances (such as Aloe Vera) in anti-boil fluids. An advantage of the invention is that the combination prevents corrosion of the cooling system of an engine while simultaneously preventing evaporation loss of water from the coolant. Another advantage of the invention is that the hygroscopic substances impart a longer shelf life to the invented coolant and increase time between coolant fill ups.

Still yet another object of the invention is to provide a water-based coolant that is eco-friendly and non-toxic. A feature of the invention is the use of Aloe Vera and other ingredients that are non-toxic to the environment or humans without the use of glycols. An advantage of the invention is that the invented coolant effectively cools an engine and prevents corrosion of the engine and its cooling system while neither polluting the environment nor presenting a safety risk to humans.

Briefly, an embodiment of the invention provides a water-based coolant formulated to prevent water evaporation, the coolant comprising: between about 25 and about 100 ml/L extract of a humectant containing quinone compounds dissolved in water; and between about 1 and about 10 g/L of at least one corrosion inhibitor dissolved along with the extract of Aloe Vera.

Also provided is a method for cooling engines, the method comprising: dissolving between about 25 and about 100 ml/L extract of a humectant containing quinone group compounds in water; dissolving between about 1 and about 10 g/L of at least one corrosion inhibitor dissolved along with the extract of the humectant; and providing the solution obtained from steps a and b to the liquid cooling system of an engine.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a plot depicting water lost to evaporation over a period of 72 hours based on concentration of dissolved Aloe Vera Extract, in accordance with the features of the invention;

FIG. 2 is a plot depicting water lost to evaporation over a period of 96 hours based on concentration of dissolved Aloe Vera Extract, in accordance with the features of the invention;

FIG. 3 is a plot depicting water lost to evaporation over a period of 120 hours based on concentration of dissolved Aloe Vera Extract, in accordance with the features of the invention;

FIG. 4 depicts a plot comparing water lost to evaporation from a commercially available engine coolant and the invented water-based coolant over a period of 113 hours, in accordance with the features of the invention;

FIG. 5 is a plot comparing the impedance value of the invented water-based coolant to three commercially available coolants, in accordance with the features of the invention; and

FIG. 6 is a cyclic polarization plot comparing the anodic current of the instant invention and three commercially available coolants, in accordance with the features of the invention; and

FIG. 7 is a schematic showing the formulation of a complex with Aloe Vera extract and a metal surface in contact therewith, in accordance with the features of the present invention.

### DETAILED DESCRIPTION OF THE INVENTION

The foregoing summary, as well as the following detailed description of certain embodiments of the present invention, will be better understood when read in conjunction with the appended drawings.

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The instant invention minimizes evaporation losses in water-based engine coolants, such that less than 50 percent of water is lost during a period of more than 110 hours of running time. In an embodiment of the invention, less than 50 percent of water was lost after 113 hours of running time. The present invention also incorporates a combination of corrosion inhibitors that provide synergistic protection to metals and alloys normally used in cooling systems of mobile and stationary engines.

In general, this invention is directed to an engine coolant composition for combustion engines used in a tropical environment and in non-tropical environments during periods of elevated temperatures. This invention also provides advantages in any other heat transfer application used in a tropical environment and in other environs having elevated temperatures using an aqueous-based coolant system. The invented coolant composition confers excellent anti-evaporation properties onto the invented water-based coolant and therefore increases the temperature before which the coolant begins to evaporate or boil.

The present invention utilizes non-toxic humectants to prevent or minimize evaporation. In exemplary embodiments, the invented coolant includes the water soluble portions of a liquid extract of Aloe Vera in combination with anti-corrosion additives. It has been discovered that the instant invention unexpectedly exhibits improved prevention of evaporation-based water loss and metal corrosion inhibition over traditional water-based coolants. Such traditional water based coolants experience water loss in excess of 50 percent during a typical engine running time of 72 hours.

The Aloe Vera hydrogen bonds with the water solvating the extract. Also, the dissolved Aloe Vera extract forms a complex with metal surfaces exposed to the water-based coolant. The complex formed by the dissolved Aloe Vera extract and metal surfaces prevents corrosion by preventing diffusion of sub-surface metal cations through the complex, wherein the complex further prevents diffusion of oxygen. Further, the corrosion inhibitors buffer the pH of the coolant toward near neutral pH. The corrosion inhibitors further prevent corrosion of metals in contact with the water-based coolant by forming a film on the surface of the metals.

Aloe Vera and its extract is a natural product that has no known toxicity (no LD50 or LC50 Data). Thus, use of Aloe Vera extract in the instant invention in place of other, toxic humectants comprises a safe and ecofriendly water-based coolant.

These humectants, dissolved in water, reduce evaporation loss of water by forming hydrogen bonds. Suitable humectants include natural and artificial ones. Natural humectants include aloe vera extract, inositol, panthenol, glycogen, lecithin and combinations thereof. Chemically synthesized humectants comprise diols and triols, including such compounds as butylene glycol, propylene glycol, 1,2,6 hexanetriol, dipropylene glycol, hexyleneglycol, glycerin, triethylene glycol, erythritol, capryl glycol, phytantriol, hexanediol, -triol beeswax, and combinations thereof.

Other suitable humectants include hydrolyzed proteins such as elastin, collagen silk keratin, ethers isoceteth-x, isolaureth-x, laneth-x, laureth-x, steareth-x PEG-x (polyethylene glycol) silicone copolyols etc. are also employed to derive the benefits of humectants.

An embodiment of the invention utilizes the extract of leaves of Aloe Vera to reduce the evaporation of water in low temperature environs as well as high temperature environs such as tropical environments or near other running engines. Aloe Vera's effectiveness in reducing evaporation losses of water increases proportionately with its concentration in water. However, a blend of between about 0.20 and about 50 Volume/Volume percent extract of Aloe Vera was found to provide the most effective results. The Aloe Vera extract used in formulating the invented coolant is commercially obtained. An exemplary commercially obtained Aloe Vera extract is Aloe Vera extract manufactured and distributed by Herbal Hills of Mumbai, India. Alternatively, the Aloe Vera extract can be prepared using Aloe Vera leaves.

Aloe Vera belongs to the Liliaceae family and grows in warm regions, mainly in tropical and sub-tropical countries. Many varieties of Aloe Vera exist in nature that vary in their medicinal values. However, due to the presence of hydrogen bond-forming compounds described below within Aloe Vera, Aloe's properties as a humectant are universal across all varieties, such that any Aloe Vera extract will suffice for use in the instant formulation. A majority of aloe varieties are rich in polysaccharides, fatty acids, proteins, vitamins, minerals and many other organic molecules.

Aloe Vera contains α-D-glucose, β-D-glucose, malic acid, acetylated polysaccharide, acetic acid, lactic acid, formic acid and fumaric acid. Malic acid is a secondary alcohol with two carboxylic groups attached by a carbon atom. In addition to these components, quinine and anthrax quinines are also found in the extract of Aloe Vera. Due to the presence of different types of sugars and carboxylic acids that form hydrogen bonds, Aloe Vera is an effective humectant and minimizes the evaporation of water.

### Coolant Formula

### Detail

The instant invention provides a water-based coolant that is free from glycols or any other toxic cooling liquid. An embodiment of the invented coolant comprises preferably about 0.2 to about 50 percent (volume by volume), more preferably about 1 to about 20 percent (volume by volume), and most preferably about 2.5 to about 10 percent (volume by volume) of the extract of leaves of Aloe Vera mixed in water. Neat water is preferred and distilled water most preferably.

The addition of Aloe Vera in water reduces evaporation loss of water by 25-35 percent at room temperature. When kept at elevated temperatures (80-85° C.) the reduction of evaporation loss is 15-20 percent in comparison to a neat water control.

To prevent corrosion of metals present in the cooling circuit of an engine using the instant invention, the invented water-based coolant is blended with a number of organic and inorganic compounds at various concentrations, determined empirically. In an embodiment, the organic additives comprise salicylic acid, azole derivatives, namely 1,2,3, benzotriazole, tolyltriazole or combinations thereof, benzoate salts of sodium, potassium, lithium, ammonium, zinc, and combinations thereof. These salts are effective in controlling the corrosion rate of metals when used independently and also exhibit synergism with other additives in protecting the metals against corrosion.

In an embodiment, the invented water-based coolant also incorporates inorganic compounds comprising nitrites and nitrates such as sodium nitrite, potassium nitrite, lithium nitrite, ammonium nitrite or mixtures thereof and sodium nitrate, potassium nitrate, lithium nitrate, ammonium nitrate, borax and combinations thereof. Protective properties of the instant invention further improves in the presence of a small amount of organic and or inorganic phosphate compounds such as Tri-phenyl phosphate, tri sodium phosphate, sodium di hydrogen phosphate, ammonium phosphate and combinations thereof. Such phosphate compounds protect metal coolant components by forming a thin film over the surface of such components. Alone, these phosphate compounds imbue anti-corrosive properties to water-based coolants. The anti-corrosive properties of the phosphate compounds persist in the presence of other corrosion inhibitors. Metals and alloys normally found in cooling loops of the engines are protected by the instant invention as shown and described below.

In an exemplary embodiment, the invented water-based coolant is formulated by dissolving extract of aloe vera, sodium nitrate, 1,2,3, benzotriazole, tri sodium phosphate and sodium benzoate in de-mineralized water. In this exemplary embodiment, the formulated coolant comprises about 5 to about 100 ml/liter extract of Aloe Vera, preferably about 5 to about 25 ml/liter and more preferably about 20 to about 25 ml/liter; about 2.5 to about 35 g/liter of sodium benzoate salt, preferably about 10 to about 35 g/liter and more preferably about 20 to about 25 g/liter; about 1 to about 25 g/liter of sodium nitrate, preferably about 2.5 to about 25 g/liter and more preferably about 5 to about 10 g/liter; about 0.25 to about 15 g/liter of tri sodium phosphates, preferably about 0.5 to about 10 g/liter and more preferably about 1 to about 5 g/liter; about 0.5 to about 5 g/liter of 1,2,3, benzotriazole, preferably 0.5 to 2.5 g/liter and more preferably 1 to 2 g/liter; about 2.5 to about 15 g/liter of salicylic acid, preferably 1 to 5 g/liter and more preferably 1.5 to 2 g/liter; about 0.25 to 15 g/liter of borax (sodium tetraborate decahydrate), preferably 0.5 to 10 g/liter and more preferably 1 to 5 g/liter. This is an exemplary embodiment that is not meant to be limiting. One having ordinary skill in the art could see where the inhibitors above could be substituted for other inhibitors known in the art or where the ranges given above could be adjusted. Such adjustments would still be within the teachings of this disclosure.

In an alternative embodiment, the invented water-based coolant comprises about 25 to 100 ml/liter extract of Aloe Vera and between about 1 to 10 g of at least one corrosion inhibitor wherein the at least one corrosion inhibitor comprises benzoate salts, sodium nitrate, phosphates, triazoles, salicylic acid, borax, and combinations thereof.

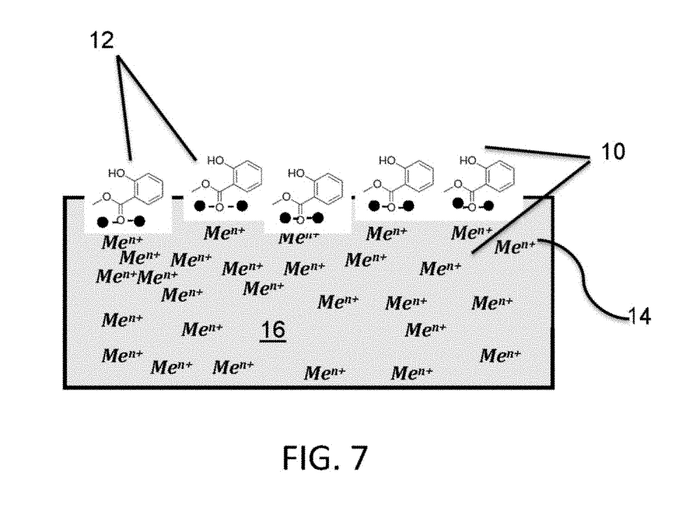

The above-referenced inhibitors when in solution prevent corrosion of metals and alloys typically found in cooling components of engines especially in the presence of dissolved extract of Aloe Vera. Constituents of dissolved extract of Aloe Vera interact with metals in contact with the dissolved Aloe Vera solution such that the Aloe Vera constituents form complexes with metal cations at the metal's surface. (See FIG. 7). This Aloe Vera-metal cation complex prevents diffusion of sub-surface metal ions through the complex, therefore preventing metal loss. The Aloe Vera-metal cation complex further prevents metal corrosion by preventing the diffusion of oxygen through the Aloe Vera-cation complex, as oxidation is a major cause of the corrosion of metals in contact with aqueous solution.

The formation of the complex 10 mentioned above is demonstrated by the schematic shown in FIG. 7. The complex 10 is formed between quinone moieties 12 within Aloe Vera extract used in instant invention and metal surfaces. Lone pairs from oxygen atoms disposed in the quinone moieties 12 interact with positive metal ions 14 that comprise a metal surface 16. When the quinone moieties 12 interact with the positive metal ions 14, the quinone moieties 12 and the larger Aloe Vera extract are adsorbed onto the metal surface 16. With the surface metal ions 14 occupied, there are less places where the metal surface can react with water and/or oxygen to corrode.

Surprisingly and unexpectedly, the inventors found that adding the organic and inorganic inhibitors discussed above to a solution of dissolved Aloe Vera extract has a synergistic effect on preventing metal corrosion as shown and discussed below. These organic and inorganic inhibitors aid in preventing the corrosion of metals exposed to the instant water-based coolant by buffering the solution such that the pH of the overall solution is biased toward a neutral pH. The inhibitors further prevent corrosion of metals by forming a film on the surface of metals coming in contact with the invented water-based coolant.

### Coolant Preparation Detail

To prepare the invented coolant, the desired amount of commercially purchased Aloe Vera extract is placed in deionized water and allowed to dissolve with mechanical stirring for about two to about four hours at room temperature. After the Aloe Vera extract is allowed to dissolve, any insoluble plant material is filtered from solution using porous cloth or a filter flask. Due to the universal humectant properties across the varieties of Aloe Vera, the extract of any type of Aloe Vera is suitable for use with the present invention. Desired inhibitors are then dissolved into the filtrate with the aid of mechanical stirring. When dissolution of the inhibitors is complete, the invented water-based coolant is complete and has a pale yellow, transparent appearance. The pH of the invented water-based coolant formulation ranges between about 7 to about 8.5. This variation in pH is due to variation in type of Aloe Vera used to formulate the coolant. It is further observed that this variation in pH has no effect either on evaporation losses or metals protection

### Water Evaporation Loss

### Prevention Detail

Several experiments were performed to demonstrate the effectiveness of the invented water-based coolant on preventing loss of water to evaporation based on the concentration of dissolved extract of Aloe Vera in the test solution. For these experiments, the water-based coolant was formulated with concentrations of organic and inorganic corrosion inhibitors according to the exemplary embodiment given above while varying the concentration of dissolved extract of Aloe Vera. Test solutions were kept in 500 mL graduated conical flasks made of glass, each flask containing 400 mL of test solution. The temperature of the solutions was maintained at about 50° C. by keeping them on a heating plate. The mouths of the flasks were left open to the atmosphere during the period of tests.

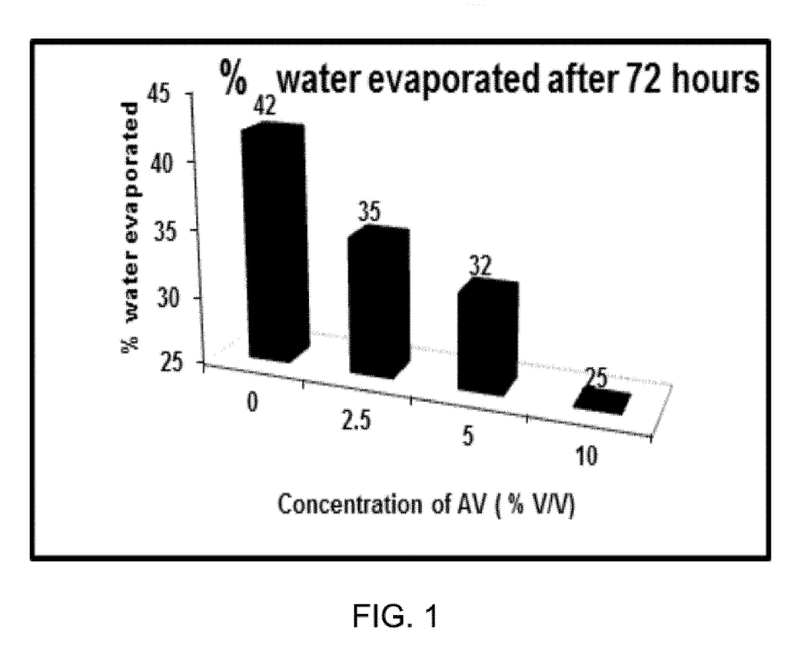

FIG. 1 shows the amount of water evaporated from test solutions that were heated at a constant 50° C. for 72 hours. As can be seen from FIG. 1, water lost to evaporation decreased according to an approximately linear relationship as the concentration of dissolved extract of Aloe Vera increased.

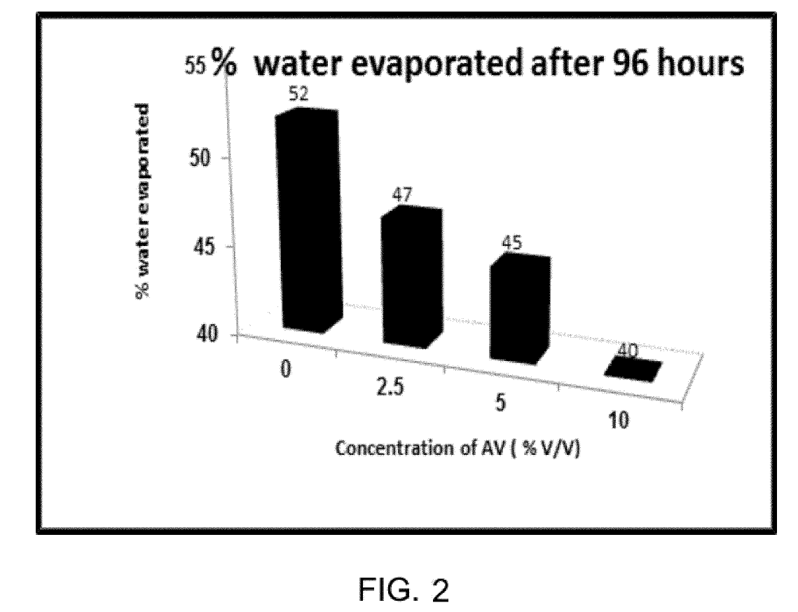

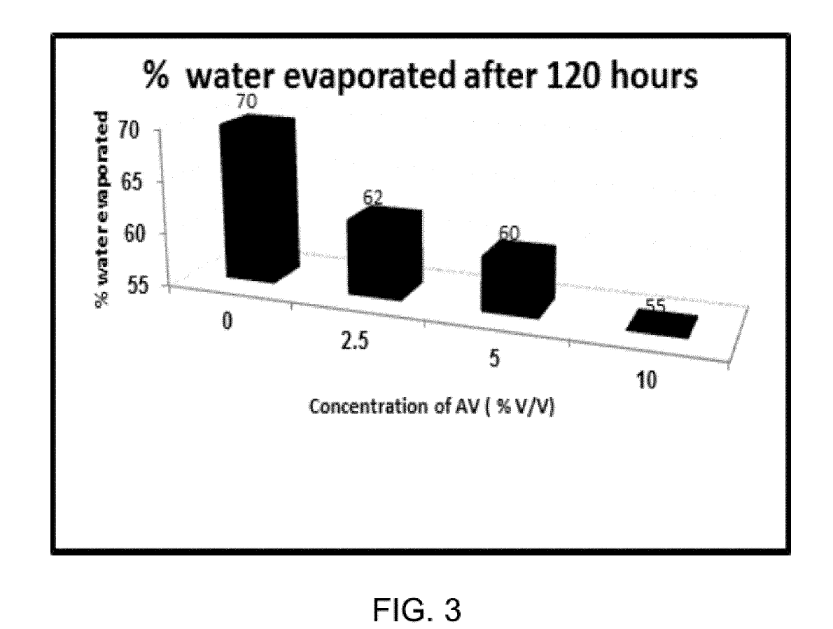

FIGS. 2-3 show the amount of water evaporated from test solutions that were heated to a constant 50° C. for 96 hours and 120 hours respectively with test solutions differing in concentration of dissolved Aloe Vera extract.

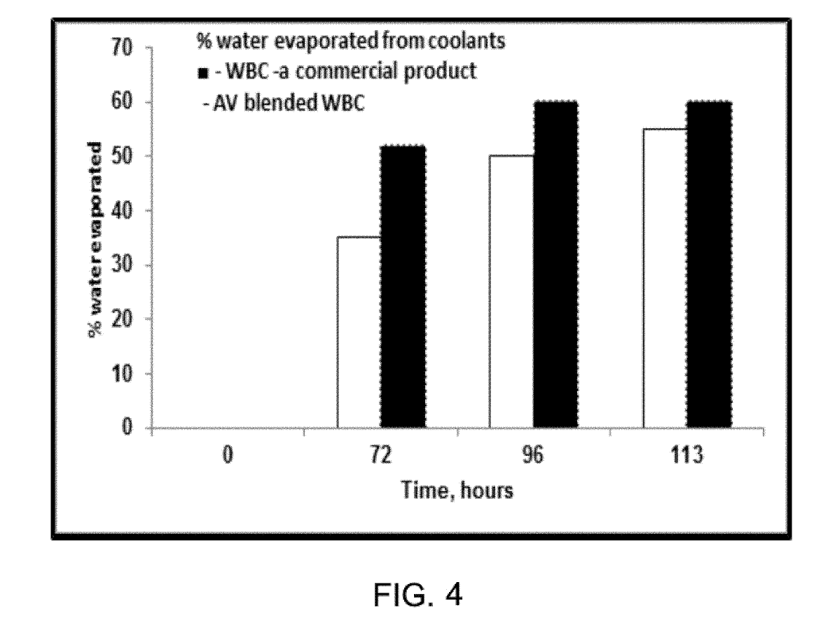

FIG. 4 illustrates the difference in evaporation losses between the invented water-based coolant and a commercially available water-based coolant. The test parameters were the same as described for the experiment whose results are shown as FIG. 1. The invented coolant used for this experiment was formulated using 2.5 percent extract of Aloe Vera and concentrations of inhibitors as described in the exemplary embodiment above. FIG. 4 demonstrates that the evaporation loss for the invented coolant imparts a considerably lower rate of evaporation vis-à-vis the coolant commercially available in the market. With this lower rate of evaporation, the invented coolant has the additional advantage over commercial coolants of having a longer shelf life. For example, the invented coolant was as effective in preventing water evaporation and preventing the corrosion of metals three months after preparation.

### Corrosion Prevention Detail

An experiment was performed to demonstrate the corrosion prevention imbued on the invented water-based coolant by the selected inhibitors and dissolved extract of Aloe Vera. This experiment tested the rate of corrosion of cold rolled steel and aluminum exposed to water having various solutes. The composition of the water was as follows: Distilled water+100 ppm chloride+100 ppm; Sulfate+100 ppm carbonate (preferably sodium salts). The synthetic service water was formulated according to the ASTM D1384-05 (Reapproved 2012) manual for standard test methods for corrosion testing for engine coolants in glassware. The samples were exposed under stagnant conditions for 67 days at 50° C.±3° C.

The results incorporated in Table 1 show that the synthetic service water is quite corrosive for steel without any dissolved inhibitors. For the aluminum samples, however, some weight gain was recorded for aluminum samples exposed to synthetic service water without dissolved inhibitors. The surface of aluminum samples turned grayish indicating the formation of a very protective alumina passive film.

Table 1 also incorporates the results of contacting steel and aluminum metals with a mixture of glycerin and extract of Aloe Vera with and without the addition of the developed inhibitors referenced above. From the table, it can be seen that generally, the addition of glycerin and Aloe Vera inhibited the corrosion rate of steel and aluminum. However, for steel, the corrosion inhibition was more significant for solutions incorporating Aloe Vera than glycerin. The enhanced inhibition by Aloe Vera is due to the presence of quinone group compounds in its composition. Such molecules are not present in glycerin. The inventors have discovered that the quinone moieties present in Aloe Vera extract compounds interact with metal surface ions, resulting in adsorbtion of extract compounds onto metal surfaces. This adsorption prevents interaction of water and oxygen with metal surfaces and thus prevents oxidation and corrosion. Also for steel, a combination of Aloe Vera and increased concentrations of glycerin aggravated corrosion rates.

TABLE 1
Results for steel and aluminum samples exposed in
test electrolytes at 50° C., Size of the samples 5 ×
2.5 cm² Total exposure days = 67 = 1608 hours

| | | Corrosion rate of | Corrosion rate of |
|---|---|---|---|
| Solution | | Cold rolled steel, | Aluminum, |
| No. | Test electrolyte | μm/y | μm/y |
| 1. | Synth. Service water | 61.3 | +0.0322 |
| 2. | Synth. Service water + | 1.25 | 0 |
| | Developed inhibitors | | |
| 3. | Synth. Service water + | 1.21 | 0.0007 |
| | Developed inhibitors + | | |
| | 25 ml/lit AV | | |
| 4. | Synth. Service water + | 1.25 | +0.0005 |
| | Developed inhibitors + | | |
| | 25 ml/lit Glycerin | | |
| 5. | Synth. Service water + | 2.2 | 0.0004 |
| | Developed inhibitors + | | |
| | 25 ml/lit AV + 10 ml/lit | | |
| | Glycerin | | |
| 6. | Synth. Service water + | 2.7 | 0.0002 |
| | Developed inhibitors + | | |
| | 25 ml/lit AV + 20 ml/lit | | |
| | Glycerin | | |
| 7. | Synth. Service water + | 3.2 | 0.0002 |
| | Developed inhibitors + | | |
| | 25 ml/lit AV + 30 ml/lit | | |
| | Glycerin | | |
| 8. | Synth. Service water + | 36.1 | 0.0115 |
| | 25 ml/lit AV | | |
| 9. | Synth. Service water + | 50.01 | 0.001 |
| | 25 ml/lit Glycerin | | |

pH of pure Aloe-Vera bought from the market = 3.58,
Conductivity = 3.105 ms at 21.6° C.

Another experiment was performed to determine the performance of corrosion inhibitors in controlling the corrosion rates of mild steel, galvanized steel, aluminum, copper, and brass. The experiment was performed by exposing 5 cm×2.5 cm metallic specimens in a water solution of 25 mL/lit Aloe Vera mixed with the following salts: sodium sulfate 148 mg, sodium chloride 165 mg, and sodium bicarbonate 138 mg. The tests were performed at 88° C.±2° C. for the duration of 14 days as recommended in ASTM D1384-05 (2012). The results of this experiment, shown in table 2 below, demonstrate that a mixture of organic and inorganic inhibitors in combination with the extract of Aloe Vera provides a very high degree of protection to Al, steel, copper and brass.

TABLE 2
Corrosion Results of Al, Copper, Brass, and Steel
exposed to solutions of various inhibitors

| Inhibitors and their concentrations | Loss of different metals in mg | | | |
|---|---|---|---|---|
| (w/v), except Aloe Vera which was | (average of three samples) | | | |
| added as ml/lit | Al | Copper | Brass | Steel |
| 10 g/lit Sodium Benzoate + 10 g/lit | 87 | 36 | 56 | 23 |
| Sodium nitrate | | | | |
| 10 g/lit Sodium Benzoate + 10 g/lit | 56 | 34 | 45 | 16 |
| Sodium nitrate + 10 g/lit | | | | |
| Tri sodium phosphate | | | | |
| 10 g/lit Sodium Benzoate + 10 g/lit | 11 | 8 | 11 | 9 |
| Sodium nitrate + 10 g/lit Tri sodium | | | | |
| phosphate + 5 g/lit 1,2.3 Benzotriazole | | | | |
| 10 g/lit Sodium Benzoate + 10 g/lit | 4 | 5 | 9 | 3 |
| Sodium nitrate + 10 g/lit Tri sodium | | | | |
| phosphate + 5 g/lit 1,2.3 | | | | |
| Benzotriazole + 1 g/lit Salicylic acid | | | | |
| 10 g/lit Sodium Benzoate + 10 g/lit | 6 | 5 | 10 | 2 |
| Sodium nitrate + 10 g/lit Tri sodium | | | | |
| phosphate + 5 g/lit 1,2.3 Benzotriazole + | | | | |
| 1 g/lit Salicylic acid + 2 g/lit Borax | | | | |
| 10 g/lit Sodium Benzoate + 10 g/lit | 6 | 6 | 6 | 1 |
| Sodium nitrate + 10 g/lit Tri sodium | | | | |
| phosphate + 5 g/lit 1,2.3 Benzotriazole + | | | | |
| 1 g/lit Salicylic acid + 2 g/lit Borax + | | | | |
| 1.0 ml/lit extract of Aloe-Vera | | | | |
| 10 g/lit Sodium Benzoate + 10 g/lit | 4 | 5 | 6 | 1 |
| Sodium nitrate + 10 g/lit Tri sodium | | | | |
| phosphate + 5 g/lit 1,2.3 Benzotriazole + | | | | |
| 1 g/lit Salicylic acid + 2 g/lit Borax + | | | | |
| 25 ml/lit extract of Aloe-Vera | | | | |
| 10 g/lit Sodium Benzoate + 10 g/lit | 2 | 3 | 3 | 1 |
| Sodium nitrate + 10 g/lit Tri sodium | | | | |
| phosphate + 5 g/lit 1,2.3 Benzotriazole + | | | | |
| 1 g/lit Salicylic acid + 2 g/lit Borax + | | | | |
| 50 ml/lit extract of Aloe-Vera | | | | |
| 10 g/lit Sodium Benzoate + 10 g/lit | +1 | +1 | 0 | 0 |
| Sodium nitrate + 10 g/lit Tri sodium | | | | |
| phosphate + 5 g/lit 1,2.3 Benzotriazole + | | | | |
| 1 g/lit Salicylic acid + 2 g/lit Borax + | | | | |
| 100 ml/lit extract of Aloe-Vera | | | | |

(+sign indicates weight gain)

Two more experiments were performed to determine the comparative performance of optimized coolant composition vis-à-vis a water-based commercial coolant available on market. These tests were conducted by using electrochemical techniques such as impedance, polarization resistance, potential-time plots and cyclic polarization; a technique normally employed to assess the pitting tendency of metals and alloys in a specific environment.

The coolant tested during this set of experiments was prepared by mixing Aloe Vera in the concentration range of 1-250 ml/liter, preferably 10-100 ml/liter and more preferably in the range of about 25 ml to about 80 ml/liter in distilled water. Sodium benzoate (about 2.5 to about 25 g/liter), sodium nitrate (about 1 to about 40 g/liter), sodium nitrite (about 2.5 to 50 g/liter), salicylic acid (about 0.5 to 2.5 g/liter), tri sodium phosphate (about 0.25 to 5 g/liter), tri phenyl phosphate (about 0.25 to about 1 g/liter), 1,2,3 Benzotriazole (about 0.1 to about 1.0 g/liter) were mixed thoroughly. These additives were dissolved and transferred to a beaker where the volume was titrated to one liter with neat water. In an embodiment, the beaker was stirred and the temperature of the solution was raised to between about 40 to about 70° C. and preferably in the range of about 40 to about 60° C. Stirring continued for about 2 hours (for example using a magnetic stirrer) while maintaining the above temperatures. Thereafter the solution was allowed to cool to ambient temperature. In an embodiment, the stirring occurs at ambient temperature and the solution can be used immediately.

A solution produced according to the above procedure was used as the test electrolyte for the electrochemical tests below. All the tests were performed at 25° C.±2° C. Calomel electrode and graphite rods were used as the reference and auxiliary electrodes respectively. The results are summarized in the following figures.

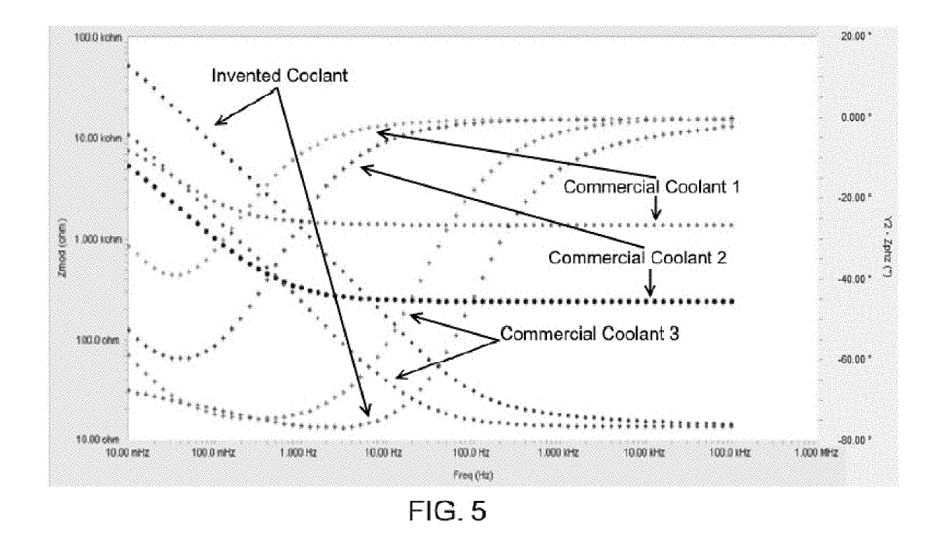

FIG. 5 shows plots of the impedance of steel specimens exposed in the invented water-based coolant and three other commercially available coolants. Impedance is plotted on the vertical-axis. The frequency of sinusoidal voltage applied on the test specimens is on the horizontal-axis. The corrosion rate is inversely proportional to the value of impedance. Impedance is the sum of different types of resistances that inhibit the flow of current and hence corrosion rate of metals. Thus, more impedance will result in slower rate of corrosion.) From FIG. 5, it can be seen that the invented water-based coolant inhibits corrosion about 10 times better than any of the tested commercially available coolants. The left side “Y” axis corresponds to Zmd (sum of impedance values) whereas the right side “Y” axis denote phase changes during change of frequency of the potential used by the instrument. The later part of curves are used to describe the mechanism of the inhibition.

As shown in FIG. 5, the invented coolant impendence response was maximal except for the points where the measured sinusoidal waves intersected, between 10 Hz and 100 Hz. Otherwise, the impendence of the sample treated with the invented coolant quickly assumed the maximum difference value.

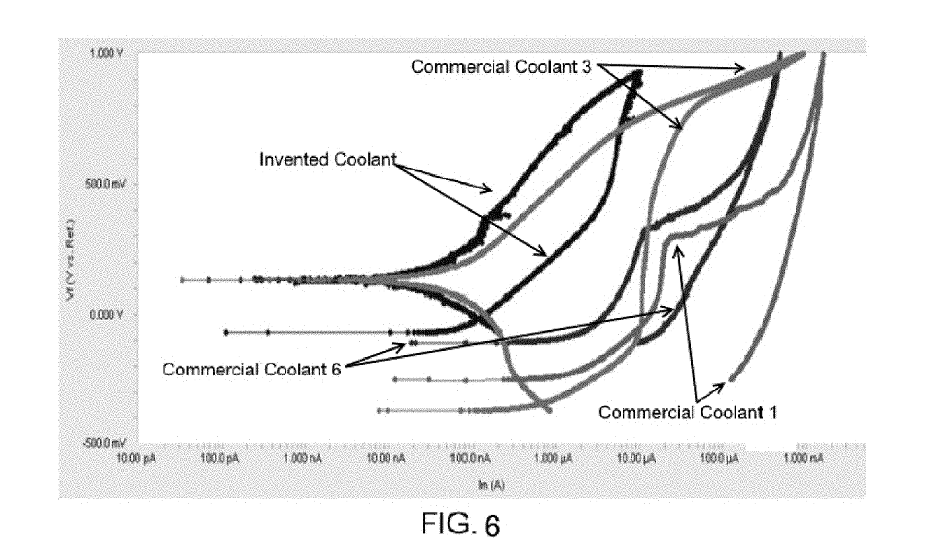

FIG. 6 shows cyclic polarization plots of the invented water-based coolant and other commercial coolants. The invented water-based coolant generates lower anodic current than the other commercial coolants indicating better corrosion protection.

### Performance Detail

The performance of the invented coolant as formulated and tested above is being used in an ongoing performance test that has been ongoing for 15 months (between September 2015 and November 2016). During this period, the invented coolant was used as the sole engine coolant in a normally operating vehicle on the island of Trinidad and Tobago (a tropical climate) as it traveled 1,657 km and idled for more than 20 hours. At the time of the preparation of this Non-Provisional application, surprisingly and unexpectedly, the invented coolant used in testing experienced no measurable water loss. At the commencement of this testing, and the charging of the coolant tank with the invented coolant, the concentration of Fe and Al cations in the coolant were <0.1 ppm. When the installed coolant was tested again at the time of drafting this Non-Provisional application, the concentration of Fe and Al cations in the coolant was unchanged. This demonstrates that metal corrosion had been effectively inhibited for 15 months by the invented coolant. Further, no non-metal parts of the engine exhibited any wear during this testing period.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The present methods can involve any or all of the steps or conditions discussed above in various combinations, as desired. Accordingly, it will be readily apparent to the skilled artisan that in some of the disclosed methods certain steps can be deleted or additional steps performed without affecting the viability of the methods.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

The embodiment of the invention in which an exclusive property or privilege is claimed is defined as follows:

1. A water-based coolant formulated to prevent water evaporation, the coolant comprising:
a) between about 25 and about 100 ml/L extract of a humectant containing quinone compounds dissolved in water; and
b) between about 1 and about 10 g/L of at least one corrosion inhibitor dissolved along with the extract.

2. The water-based coolant of claim 1 wherein the at least one corrosion inhibitor is a moiety selected from the group consisting of benzoate, nitrate, phosphate, triazoles, salicylic acid, borax, and combinations thereof.

3. The water-based coolant of claim 2 wherein the moieties are salts or neat compounds.

4. The water-based coolant of claim 1 wherein the extract comprises Aloe Vera.

5. The water-based coolant of claim 1 wherein the at least one corrosion inhibitor is a combination of borax and salicylic acid.

6. A method for cooling engines, the method comprising:
a) dissolving between about 25 and about 100 ml/L extract of a humectant containing quinone group compounds in water;
b) dissolving between about 1 and about 10 g/L of at least one corrosion inhibitor dissolved along with the extract of the humectant; and
c) providing the solution obtained from steps a and b to the liquid cooling system of an engine.

7. The method of claim 6 wherein the at least one corrosion inhibitor is a moiety selected from the group consisting of benzoate, nitrate, phosphate, triazoles, salicylic acid, borax, and combinations thereof.

8. The method of claim 7 wherein the moieties are salts or neat compounds.

9. The method of claim 6 wherein the humectant is Aloe Vera and the humectant prevents evaporation of the water of the water-based coolant.

10. The method of claim 6 wherein the at least one corrosion inhibitor is a combination of borax and salicylic acid.

11. The method of claim 6 wherein the extract prevents water evaporation by hydrogen bonding with the water solvating the extract.

12. The method of claim 6 wherein the dissolved extract forms a complex with metal surfaces exposed to the water-based coolant.

13. The method of claim 12 wherein the complex formed by the extract and metal surfaces prevents corrosion by preventing diffusion of sub-surface metal cations through the complex; and wherein the complex further prevents diffusion of oxygen.

14. The method of claim 6 wherein the corrosion inhibitors prevent corrosion of metals in contact with the water-based coolant by buffering the pH of the coolant toward near neutral pH.

15. The method of claim 6 wherein the corrosion inhibitors prevent corrosion of metals in contact with the water-based coolant by forming a film on the surface of the metals.

16. A method for minimizing metal corrosion, the method comprising contacting metal surfaces with a solution of extract of a humectant containing quinone-group compounds.

17. The method as recited in claim 16 wherein the extract combines with cations on surfaces of the metal.

18. The method as recited in claim 16 wherein the contacting occurs at temperatures above 80° C.

19. The method as recited in claim 16 wherein the solution is not in chemical communication with the ambient atmosphere.

20. The method as recited in claim 16 wherein the extract is part of an aqueous solution maintained at ambient pressure for a time and at above ambient pressure for a time.
